(19) United States
(12) Patent Application Publication
(10) Pub. No.: US 2010/0095813 A1
(43) Pub. Date: Apr. 22, 2010

(54) Socket with a Clear Marking Unit

(76) Inventor: Shu-Yuan HSIEH, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/253,183

(22) Filed: Oct. 16, 2008

(51) Int. Cl. B25B 23/14; B25B 13/06

(52) U.S. Cl. 81/468; 81/121.1

(57) ABSTRACT

A socket apparatus includes a socket and a marking unit. The marking unit includes an indented mark made in an external side of the socket, a colored mark disposed in the indented mark and a coating provided on the external side of the socket, beyond the colored mark. The color of the coating is in strong contrast with the color of the colored mark so that the colored layer is clear amid the coating.

### FIELD OF INVENTION

The present invention relates to a socket wrench and, more particularly, to a socket with a clear marking unit.

### BACKGROUND OF INVENTION

To drive a threaded bolt or nut, an open-ended wrench, box-ended wrench, monkey wrench or socket wrench may be used. A socket wrench kit includes a handle and a set of sockets of various sizes. In operation, the handle is connected to a selected one of the sockets for driving a threaded bolt or nut of a certain size. Thus, a socket wrench kit can be used to drive threaded bolts or nuts of various sizes. A socket wrench kit is lighter and less expensive than a set of open-ended wrenches or box-ended wrenches. The handle of a socket wrench kit often includes a selective one-way driving mechanism. Therefore, a socket wrench kit is more convenient than a monkey wrench. It is important to mark the sockets of a socket wrench kit to indicate the sizes of the sockets. Traditionally, indented marks are made in the sockets by pressing. The indented marks are however unclear on the sockets. The pressing requires an expensive machine. As disclosed in Taiwanese Patent Publication No. 555626, 566272 or M243306 or U.S. Pat. No. 6,393,950, embossed marks are made on the sockets by casting or indented marks are made in the sockets by pressing. However, the embossed or indented marks are unclear on the sockets for being in the same color as the sockets. Moreover, the embossed or indented marks are limited to simple patterns because of limitation of the casting and molds used in the casting.

As disclosed in Taiwanese Patent Publication Nos. 555626 and M250756, a socket is formed with a groove and an indented mark by pressing. The indented mark is covered with an electroplated layer. A colored mark is provided on the electroplated layer. The indented mark is clear on the socket. However, the colored mark could easily be peeled from the electroplated layer because the electroplated layer is smooth.

The present invention is therefore intended to obviate or at least alleviate the problems encountered in prior art.

### SUMMARY OF INVENTION

It is the primary objective of the present invention to provide a socket with a clear and durable marking unit.

To achieve the foregoing objective, the socket apparatus includes a socket and a marking unit. The marking unit includes an indented mark made in an external side of the socket, a colored mark disposed in the indented mark and a coating provided on the external side of the socket, beyond the colored mark. The color of the coating is in strong contrast with the color of the colored mark so that the colored layer is clear amid the coating.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a socket with a mark according to the preferred embodiment of the present invention.

FIG. 2 is a cross-sectional view of the socket in a first phase of fabrication to form the mark shown in FIG. 1.

FIG. 3 is a cross-sectional view of the socket shown in FIG. 2.

FIG. 4 is a cross-sectional view of the socket in a second phase of fabrication to form the mark shown in FIG. 1.

FIG. 5 is a cross-sectional view of the socket shown in FIG. 4.

FIG. 6 is a cross-sectional view of the socket in a third phase of fabrication to form the mark shown in FIG. 1.

FIG. 7 is a cross-sectional view of the socket shown in FIG. 6.

### DETAILED DESCRIPTION OF PREFERRED EMBODIMENT

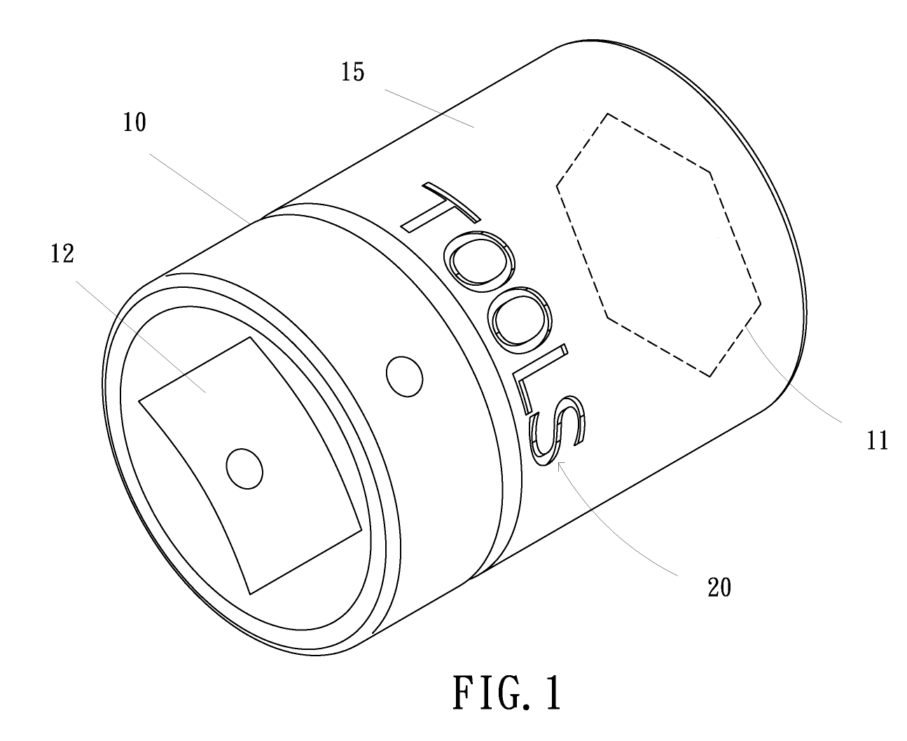

Referring to FIG. 1, there is shown a socket 10 with a marking unit 20 according to the preferred embodiment. The marking unit 20 is used to mark the size, trademark or manufacturer of the socket. The socket 10 and the marking unit 20 will be described in detail.

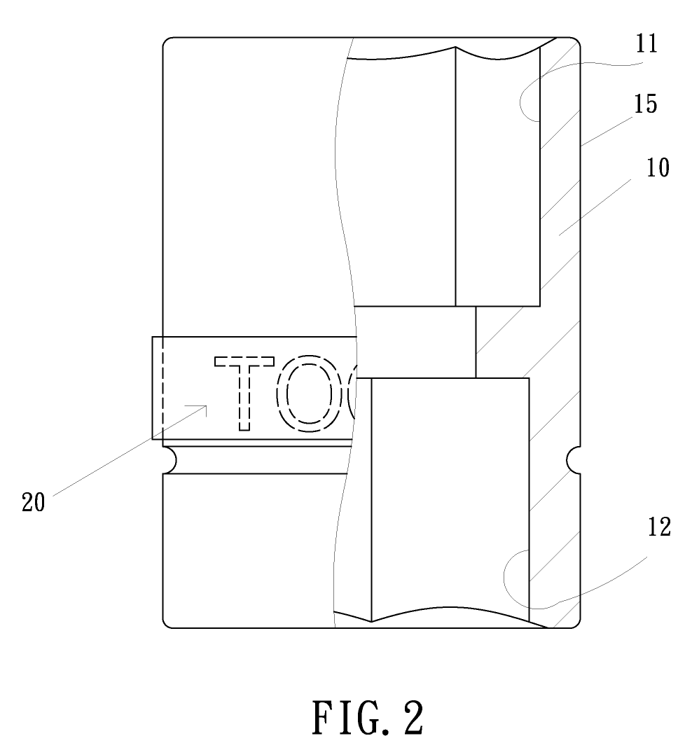

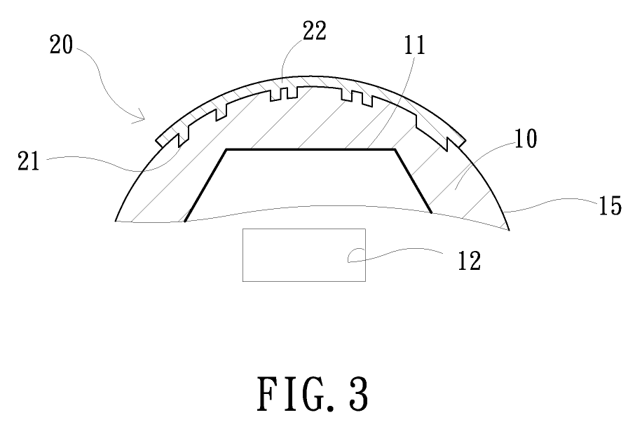

Referring to FIGS. 2 and 3, the socket 10 includes a first cavity 11 defined in a section and a second cavity 12 defined in another section. The first cavity 11 is used to receive a nut or the head of a threaded bolt. The second cavity 12 is used to receive a portion of a handle of a socket wrench kit. The socket 10 is formed with an external side 15.

An indented mark 21 is made in the external side 15 of the socket 10. A color layer 22 is provided on the external side 15 of the socket 10. The indented mark 21 and an adjacent region of the external side 15 of the socket 10 are covered with the color layer 22.

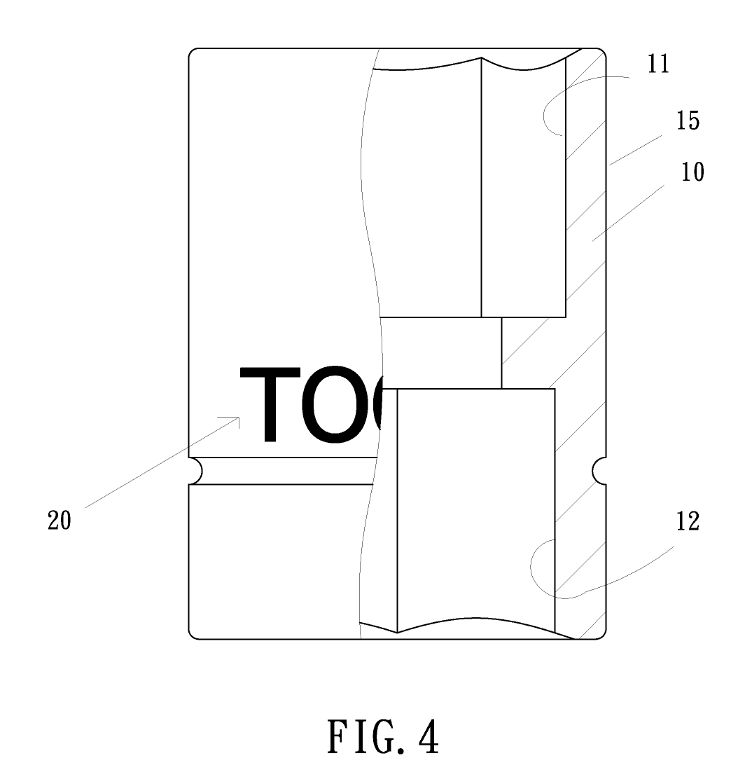

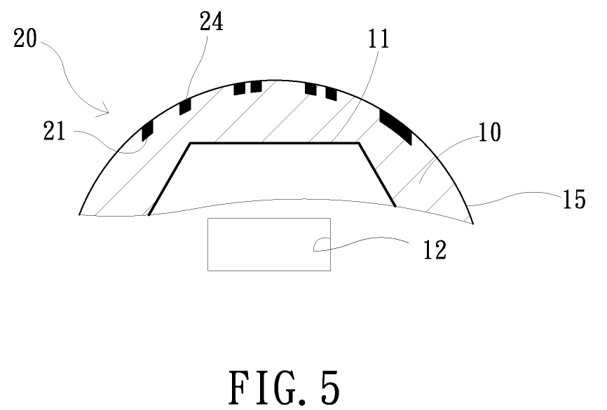

Referring to FIGS. 4 and 5, the portion of the color layer 22 beyond the indented mark 21 is removed by grinding. Thus, a colored mark 24 is left in the indented mark 21.

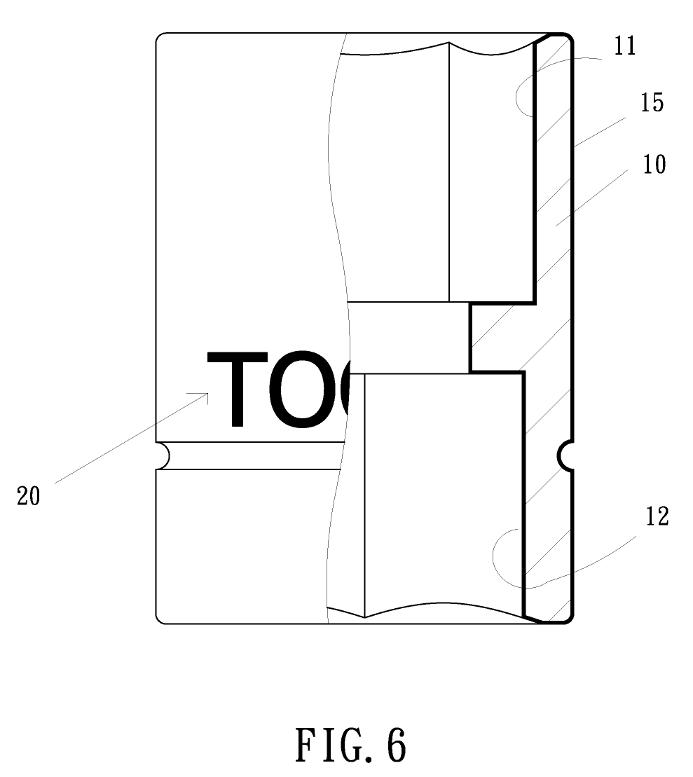

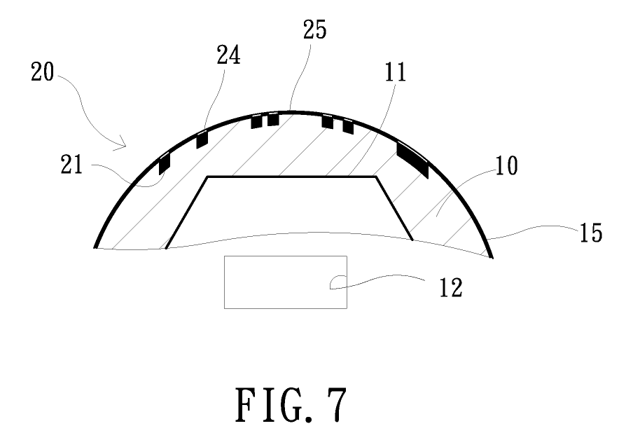

Referring to FIGS. 6 and 7, a coating 25 of manganese phosphate for example is provided on the colored mark 24 and the external side 15 of the socket 10. Some of the manganese phosphate penetrates into the colored mark 22 to make the colored mark 22 look like leather. The coating 25 however does not cover the colored mark 24. The color of the coating 25 is dark and in strong contrast with the color of the colored mark 24 so that the colored mark 24 amid the coating 25.

The socket 10 with the marking unit 20 exhibits several advantages. Firstly, the colored mark 24 is firmly attached to the indented mark 21 because the indented mark 21 is rough in comparison with an electroplated layer. Secondly, the colored mark 24 is clear amid the coating 25 because the color of the coating 25 is in strong contrast with the color of the colored mark 24.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A socket apparatus comprising:
a socket comprising an external side; and
a marking unit comprising an indented mark made in the external side of the socket, a colored mark disposed in the indented mark and a coating provided on the external side of the socket, beyond the colored mark, wherein the color of the coating is in strong contrast with the color of the colored mark so that the colored layer is clear amid the coating.

2. The socket apparatus according to claim 1, wherein the socket comprises a first cavity for receiving the head of a threaded bolt and a second cavity for receiving a portion of a handle.

3. The socket apparatus according to claim 1, wherein the marking unit is used to mark the size of the socket.

4. The socket apparatus according to claim 1, wherein the marking unit is used to mark the trademark of the socket.

5. The socket apparatus according to claim 1, wherein the marking unit is used to mark the manufacturer of the socket.

6. The socket apparatus according to claim 1, wherein the coating is made of manganese phosphate.

7. The socket apparatus according to claim 6, wherein some of the manganese phosphate penetrates the colored mark to make the colored mark look like leather while keeping the colored mark free of a coating of manganese phosphate.
